(19) United States
(12) Patent Application Publication
(10) Pub. No.: US 2005/0040151 A1
(43) Pub. Date: Feb. 24, 2005

(54) Heated side window glass

(76) Inventor: Robert Dyrdek, Elizabethtown, KY (US)

Correspondence Address: HARNESS, DICKEY & PIERCE, P.L.C., P.O. BOX 828, BLOOMFIELD HILLS, MI, 48303, US

(21) Appl. No.: 10/644,345

(22) Filed: Aug. 20, 2003

(51) Int. Cl. B60L 1/02; H05B 3/02; H05B 3/16

(52) U.S. Cl. 219/203; 219/543

(57) ABSTRACT

A heatable side window assembly for an automobile, wherein the automobile includes a sideview mirror mounted generally adjacent the heatable side window assembly. The heatable side window assembly includes a glass sheet having an interior surface and an exterior surface and a single, continuous, electrical conductor strip mounted to the interior surface of the glass sheet. The conductor strip outputs radiant heat in response to an electrical current flow therethrough. The conductor strip is positioned such that it generally bounds an area defined by an operator's line of sight to the sideview mirror of the vehicle. A pair of conductor pads are electrically coupled to the ends of the conductor strip. A switch is provided for selectively outputting a control signal and a controller is electrically coupled between a power supply and the pair of conductor pads. The controller provides electrical current to the conductor strip in response to the control signal so as to heat the area of the glass sheet generally adjacent to the sideview mirror.

### FIELD OF THE INVENTION

The present invention generally relates to side window glass and, more particularly, relates to side window glass having a portion thereof electrically heated.

### BACKGROUND OF THE INVENTION

The advantages of defogging and de-icing the windows of a vehicle have long been recognized for purposes of improving vehicle safety during inclement weather. However, unfortunately many systems used today to defog and de-ice windows of the vehicle, particularly side windows, require the vehicle's engine to first achieve a sufficient operating temperature. More specifically, many known systems used today to heat side windows employ a defrosting vent positioned adjacent a forward portion of the side window. This defrosting vent provides warm air blowing across the interior face of the side window to heat the side window. However, these systems are very inefficient when considering the time necessary to achieve sufficient heat. The warm air is a product of the vehicle's heating system, which only operates once the vehicle engine has achieved at least a minimum operating temperature. As many drivers know, modern automobile engines may require an extended amount of time to achieve this minimum operating temperature. Accordingly, attempts have been made to provide a means of directly heating side windows of a vehicle which results in applying immediate and direct heat to the window surface when desired.

U.S. Pat. No. 5,466,911, issued to Spagnoli et al., discloses an electrically heated window assembly by producing a concentration of heat at the portion of the front window through which a driver views an exterior mirror. This concentration of heat is produced by providing a pair of bus bars, positioned on opposing ends of the window, and a transparent conductive film positioned between the pair of bus bars. During operation, electricity flows from one bus bar to the other bus bar through the transparent conductive film, thereby producing heat within the film to heat the window.

However, the Spagnoli et al. system suffers from a number of significant disadvantages. By way of non-limiting example, the transparent conductive film is particularly susceptible to damage as it extends across the entire interior surface of the window. Such damage may include scrapes and/or gouges along the surface, peeling of the conductive film, or even failure of particular heating sections due to severing of the conductive film. Moreover, the Spagnoli et al. system may not minimize manufacturing costs as it includes a complicated, multi-part configuration requiring the application of bus bars, transparent conductive film, non-conductive breaks, temperature sensors, and the like.

U.S. Pat. No. 4,410,843, issued to Sauer et al., discloses an electrically controlled sliding window and proximity detector which includes a window heating system. The Sauer et al. system uses heat generated by current flowing through a series of horizontal, parallel conductors positioned generally in the upper half of the window. The series of conductors electrically interconnect a pair of bus bars, which extend along the forward and rearward edges of the window glass within view of the operator. During operation, current flows from a current source from one bus bar to the other bus bar through the conductors, which generate heat to heat the upper portion of the side window.

However, the Sauer et al. system suffers from a number of significant disadvantages. For example, the Sauer et al. system fails to directly heat the portion of the side window through which the operator views the exterior side view mirror. The Sauer et al. system heats the top portion of the side window, yet does not heat the portion of the side window adjacent the side view mirror. In fact, the lowest portion of the heated region of the Sauer et al. system generates the least amount of heat due to the increased length of the conductor relative to the other conductors. This increase length of the conductor produces a higher resistance in the conductor wire, thereby limiting current flow relative to the shorter conductors. Accordingly, in operation, the Sauer et al. system will first defog and/or de-ice the top of the side window and, thus, the operator must still wait for sufficient heat to build up to defog and/or de-ice the lower section of the heated region.

Accordingly, there exists a need in the relevant art to provide a side window glass having a heated region positioned generally within a line of sight of side view mirror. Furthermore, there exists a need in the relevant art to provide a heated side window glass that is simple in design and provides concentrated direct heating solely at the line of sight region of the glass. Still further, there exists a need in the relevant art to provide a heated side window glass that does not suffer from the disadvantages of the prior art.

### SUMMARY OF THE INVENTION

According to the principles of the present invention, a heated side window assembly for an automobile having an advantageous construction is provided. The automobile includes a sideview mirror mounted generally adjacent the heated side window assembly. The heated side window assembly includes a glass sheet having an interior surface and an exterior surface and a single, continuous, electrical conductor strip mounted to the interior surface of the glass sheet. The conductor strip outputs radiant heat in response to an electrical current flow therethrough. The conductor strip is positioned such that it generally bounds an area defined by an operator's line of sight to the sideview mirror of the vehicle. A pair of conductor pads is electrically coupled to the ends of the conductor strip. A switch is provided for selectively outputting a control signal and a controller is electrically coupled between a power supply and the pair of conductor pads. The controller provides electrical current to the conductor strip in response to the control signal so as to heat the area of the glass sheet generally adjacent to the sideview mirror.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a side view of a heated side window assembly according to the principles of the present invention.

### DETAILED DESCRIPTION OF THE PREFERRED EMBODIMENTS

The following description of the preferred embodiment is merely exemplary in nature and is in no way intended to limit the invention, its application, or uses.

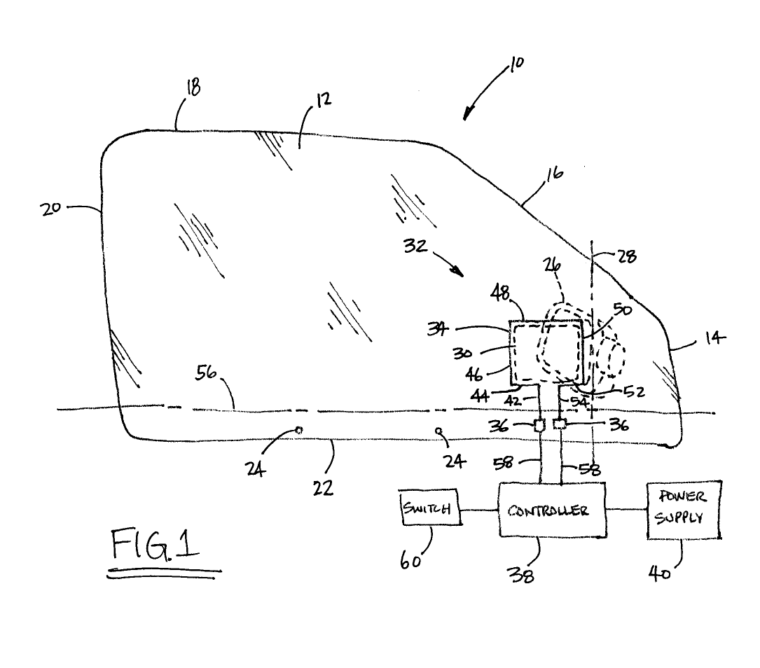

Referring to the FIG. 1, a heated side window assembly 10 is illustrated having a side window (sidelite) glass 12 adapted to be slidably mounted in a front door (not shown) of a vehicle. Sidelite glass 12 may have any shape depending on the specific vehicle configuration. It should be understood that the specific sidelite glass shape described herein is merely for illustrative purposes. It should also be understood that sidelite glass 12 may be a laminated sidelite and, thus, portions of the present invention may be disposed between layers of such laminated sidelite.

Sidelite glass 12 of the present embodiment includes a front edge 14, an inclined edge 16, a top edge 18, a rear edge 20, and a bottom edge 22. Sidelite glass 12 is shaped to be slidably received within a window opening (not shown) of the vehicle door. Sidelite glass 12 further includes a pair of apertures 24 for mounting a window operating mechanism bracket (not shown) adjacent bottom edge 22 to aid in the automatic or manual raising and lowering of sidelite glass 12.

A sideview mirror 26 is illustrated for use with heated side window assembly 10. Sideview mirror 26 is of conventional design and is mounted to at least one of the front doors of the vehicle. A nominal cover line 28 is shown which illustrates an edge of a shroud plate used for securely mounting sideview mirror 26 to the vehicle. During operation of the vehicle, an operator views sideview mirror 26 through a line of sight region 30 of sidelite glass 12. Line of sight region 30 of sidelite glass 12 is generally positioned adjacent sideview mirror 26 and within the line of sight between the operator and sideview mirror 26. Line of sight region 30 is preferably the area in which defogging and/or de-icing occurs during operation.

Heated side window assembly 10 further includes a heating system 32 for heating line of sight region 30 of sidelite glass 12. Heating system 32 includes a conductor 34, a pair of conductor pads 36, a controller 38, and a power supply 40. Conductor 34 is preferably an electrically conductive strip mounted to the interior surface of sidelite glass 12. Conductor 34 is generally square-shaped such that it includes a first leg 42, a first lower strip 44, a rear strip 46, a top strip 48, a front strip 50, a second lower strip 52, and a second leg 54, which are interconnected to provide a continuous current path between first leg 42 and second leg 54. Conductor 34 is preferably sized so as to extend generally about the periphery of line of sight region 30 of sidelite glass 12. That is, conductor 34 is preferably sized to be generally outside of the direct line of sight to sideview mirror 26 for an average size vehicle operator. This arrangement thus minimizes any visible obstructions between the operator and sideview mirror 26. Conductor 34 is preferably covered with electrically insulating enamel to protect the strips from corrosion and wear and tear. Conductor 34 may be installed on the interior surface of sidelite glass 12 via known silk-screening techniques.

First leg 42 and second leg 54 of conductor 34 each terminate into one of the pair of conductor pads 36 to provide electrical communication therebetween. The pair of conductor pads 36 are each made of an electrically conductive material. As can be seen in FIG. 1, the pair of conductor pads 36 are each positioned below a door line 56, which schematically represents the lowermost boundary of sidelite glass 12 that is exposed to view when sidelite glass 12 is in a raised position. Accordingly, it should be appreciated that the pair of conductor pads 36 is concealed from sight for improved aesthetic quality.

Each of the pair of conductor pads 36 is electrically coupled to controller 38 via a pair of lines 58, such as flexible wires. The pair of lines 58 is sized to maintain electrical communication between controller 38 and the pair of conductor pads 36 during operation of sidelite glass 12. Controller 38 may be a separate controller or, more preferably, is incorporated within the main controller of the vehicle. Controller 38 is activated by the operator of the vehicle using a switch 60. Switch 60 is of conventional design and is mounted within the passenger compartment of the vehicle. Alternatively, switch 60 may be replaced or at least supplemented by an automatic switching mechanism that activates or deactivates heating system 32 in response to expiration of a predetermined time, detection of a predetermined moisture content, etc. Controller 38 is electrically coupled to power supply 40 of the vehicle. Power supply 40 may be either the battery or alternator of the vehicle. Power supply 40 is the current source for heating system 32.

Preferably, line of sight region 30 is generally positioned adjacent sideview mirror 26 and within the line of sight between the operator and sideview mirror 26. To this end, it is most preferable to determine this line of sight region 30 through three-dimensional modelling. Firstly, it should be understood that most modern vehicles are designed for a given range of occupant sizes and, thus, the general range of spine positions within the passenger compartment of the vehicle is also generally known. This spine position helps provide a range of eye positions from which to establish a eye reference range. Furthermore, the positioning of sideview mirror 26 further establishes the boundaries of the mirror. Hence, through the use of three-dimensional modelling, the various permutations may be calculated to define line of sight region 30. Ideally, conductor 34 is positioned about line of sight region 30, without obstructing line of sight region 30, to provide the necessary directing heating of sidelite glass 12.

During operation, controller 38 received a control signal from switch 60 in response to an input by the operator, detection of moisture, etc. Controller 38 then opens an electrical circuit extending between power supply 40 and the pair of lines 58. Current then flows from power supply 40 through controller 38, a first of the pair of lines 58, a first of the pair of conductor pads 36, first leg 42, first lower strip 44, rear strip 46, top strip 48, front strip 50, second lower strip 52, second leg 54, the other of the pair of conductor pads 36, the other of the pair of lines 58, controller 38, and back to power supply 40 to define a current path. As current flows through the current path, resistance inherent in first leg 42, first lower strip 44, rear strip 46, top strip 48, front strip 50, second lower strip 52, and second leg 54 causes heat to be generated. This heat radiates generally about each strip, within heating line of sight region 30 of sidelite glass 12, to warm sidelite glass 12, thereby producing a defogging and/or de-icing effect solely within the vicinity of heating line of sight region 30.

It should be understood that due to the relative simplicity of heating system 32, it is anticipated that each of the components, including conductor 34 and the pair of conductor pads 36, may be made for after-market installation. That is, it is anticipated that conductor 34 and the pair of conductor pads 36 may be made of an electrically conductive material having an activatable adhesive applied thereto. An after-market installer could simply adhere conductor 34 and the pair of conductor pads 36 to a preferred location on the sidelites of the vehicle. Controller 38 and switch 60 may be mounted within the vehicle and coupled to an existing vehicle power supply. Controller 38 may then be electrically coupled to the pair of conductor pads via a pair of lines extending through the vehicle door hinge. Therefore, the present invention may find utility in retrofitting late model vehicles or those existing vehicles that are frequently exposed to fogging and/or icing conditions, such as in northern locations,

As can be appreciated from the foregoing discussion, heating system 32 of the present invention efficiently and economically provides direct, instantaneous heating of the portion of the sidelite glass that is within the operator's line of sight with sideview mirror 26.

The description of the invention is merely exemplary in nature and, thus, variations that do not depart from the gist of the invention are intended to be within the scope of the invention. Such variations are not to be regarded as a departure from the spirit and scope of the invention.

1. A heated side window assembly for an automobile, said automobile having a sideview mirror mounted generally adjacent said heated side window assembly, said heated side window assembly comprising:
a glass sheet having an interior surface and an exterior surface;
a single, continuous, electrical conductor strip mounted to said interior surface of said glass sheet having a pair of ends, said conductor strip outputting radiant heat in response to an electrical current flow therethrough, said conductor strip being positioned such that it generally bounds an area defined by an operator's line of sight to the sideview mirror of the vehicle;
a pair of conductor pads electrically coupled to said pair of ends of said conductor strip;
a switch selectively outputting a control signal;
a power supply; and
a controller electrically coupled between said power supply and said pair of conductor pads, said controller providing electrical current to said conductor strip in response to said control signal.

2. The heated side window assembly according to claim 1, further comprising:
an activatable adhesive disposed between said conductor strip and said interior surface of said glass sheet for selectively adhering said conductor strip to said glass sheet.

3. The heated side window assembly according to claim 2, wherein said pair of conductor pads is adapted to be located substantially below a door line of the vehicle when said glass sheet is in a closed position.

4. The heated side window assembly according to claim 3, further comprising:
a moisture sensor electrically coupled to said controller for activating said controller in response to detection of a predetermined about of moisture on said glass sheet so as to provide electrical current to said conductor strip.

5. The heated side window assembly according to claim 3, further comprising:
a timer electrically coupled to said controller for deactivating said controller after a predetermined amount of time so as to interrupt electrical current to said conductor strip.

6. The heated side window assembly according to claim 1, further comprising:
a protective insulating material extending over said conductor strip.

7. The heated side window assembly according to claim 1 wherein said operator's line of sight to the sideview mirror of the vehicle is defined by sight lines passing through said glass sheet toward the sideview mirror from a range of occupant eye positions.

8. A kit for use with a front sidelite of an automobile, the automobile having a sideview mirror mounted generally adjacent to the front sidelite such that the front sidelite includes a viewing portion through which an operator views the sideview mirror, the automobile further having a power supply, said kit comprising:
a single, continuous, electrical conductor strip having a pair of ends, said conductor strip further having an activatable adhesive mounted thereon for selectively adhering said conductor strip to the front sidelite sheet, said conductor strip outputting radiant heat in response to a current flow therethrough, said conductor strip being positionable such that it generally bounds the viewing portion of the sidelite of the vehicle;
a pair of conductor pads electrically coupled to said pair of ends of said conductor strip;
a switch selectively outputting a control signal; and
a controller electrically connectable between the power supply and said pair of conductor pads, said controller providing electrical current to said conductor strip in response to said control signal, thereby heating the viewing portion of the sidelite.

9. The kit according to claim 8, wherein said pair of conductor pads is adapted to be located substantially below a door line of the vehicle when the sidelite is in a closed position.

10. The kit according to claim 9, further comprising:
a moisture sensor electrically coupled to said controller for activating said controller in response to detection of a predetermined about of moisture on the sidelite so as to provide electrical current to said conductor strip.

11. The kit according to claim 9, further comprising:
a timer electrically coupled to said controller for deactivating said controller after a predetermined amount of time so as to interrupt electrical current to said conductor strip.

12. The kit according to claim 8, further comprising:
a protective insulating material extending over said conductor strip.

13. A side window assembly for use in a front door of an automotive vehicle, said front door having a side view mirror mounted thereto, said side window assembly having a glass sheet slidably received within window opening of said front door, said glass sheet having a viewing area generally in an operator's line of sight to said sideview mirror, the improvement comprising:
an electrical conductor strip mountable to an interior surface of the glass sheet, said conductor strip outputting radiant heat in response to an electrical current flow therethrough, said conductor strip being positionable generally in the viewing area, said conductor strip having a pair of ends;
a pair of conductor pads electrically coupled to said pair of ends of said conductor strip;
a switch selectively outputting a control signal;
a power supply; and
a controller electrically coupled between said power supply and said pair of conductor pads, said controller permitting the flow of electrical current from said power supply to said conductor strip in response to said control signal.

14. The improvement according to claim 13, further comprising:
an activatable adhesive disposed between said conductor strip and said interior surface of said glass sheet for selectively adhering said conductor strip to said glass sheet.

15. The improvement according to claim 14, wherein said pair of conductor pads is adapted to be located substantially below a door line of the vehicle when said glass sheet is in a closed position.

16. The improvement according to claim 15, further comprising:
a moisture sensor electrically coupled to said controller for activating said controller in response to detection of a predetermined about of moisture on said glass sheet so as to provide electrical current to said conductor strip.

17. The improvement according to claim 16, further comprising:
a timer electrically coupled to said controller for deactivating said controller after a predetermined amount of time so as to interrupt electrical current to said conductor strip.

18. The improvement according to claim 17, further comprising:
a protective insulating material extending over said conductor strip.
